(19) United States
(12) Patent Application Publication
(10) Pub. No.: US 2019/0237969 A1
(43) Pub. Date: Aug. 1, 2019

(54) Smart Power

(71) Applicant: Carmer Love Davis, III, Tampa, FL (US)

(72) Inventor: Carmer Love Davis, III, Tampa, FL (US)

(21) Appl. No.: 16/241,151

(22) Filed: Jan. 8, 2019

Related U.S. Application Data
(60) Provisional application No. 62/613,787, filed on Jan. 5, 2018.

(51) Int. Cl. H02J 3/14; H02J 3/38

(52) U.S. Cl. CPC H02J 3/14; H02J 2003/001; H02J 3/383

(57) ABSTRACT

The purpose of this device (“Smart Power”) that is built from UL listed components consisting of Switching circuits, batteries, capacitors, battery charging circuits, off grid inverter components safety relays assembled in one box (24″×24″) and that can be utilized in conjunction with a main power transfer switch, is to act electrically in a way to introduce a signal to the existing string inverter or micro inverters to re-activate (or “turn on”) since they were automatically and by law must turn off upon loss of utility grid power in order to prevent a back-feed scenario that would endanger the linemen making repairs. The transfer switch is used as it is intended to be used and is not a claim being made here.

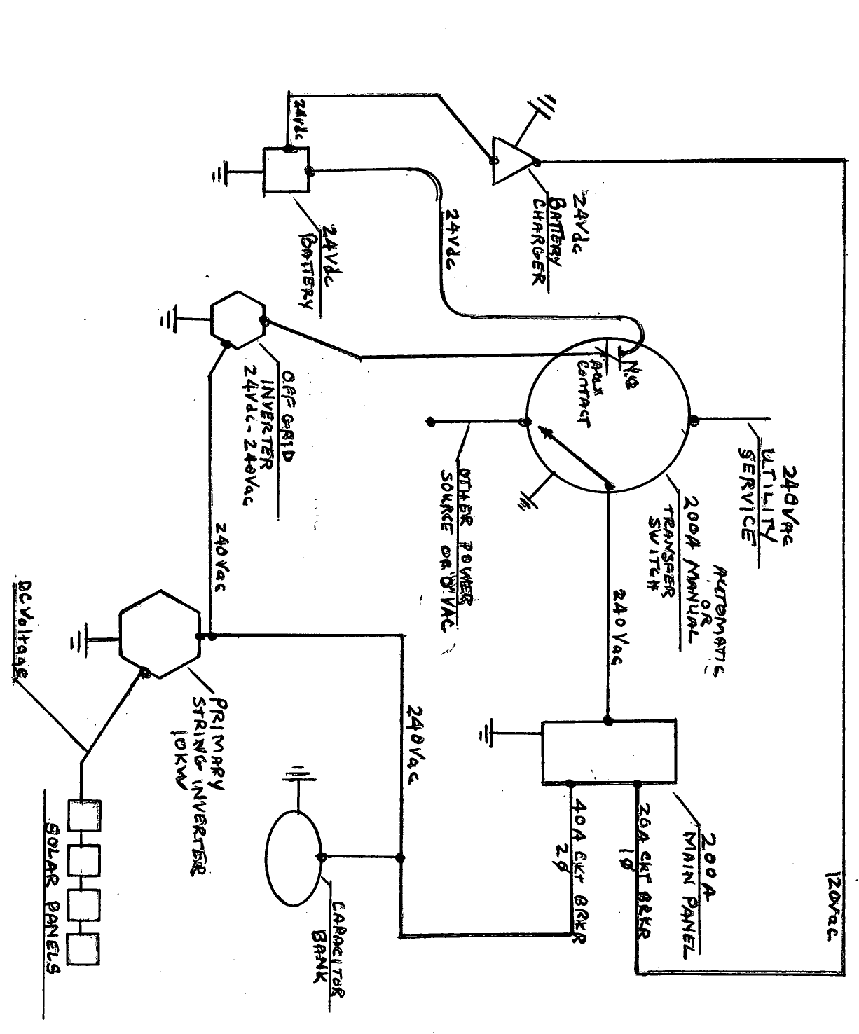

The claim is for this “Smart Power” device is that it acts electrically in a way to introduce a signal to the existing string inverter or micro inverters on or part of a solar PV (“photovoltaic”) system to re-activate or “turn on” since they were automatically and by law must turn off upon loss of utility grid power in order to prevent a back-feed scenario that would endanger the linemen making repairs. The transfer switch is used as it is intended to and is not a claim being made here.

The purpose of the “Smart Power” device is to safely re-activate a grid tied PV inverter to power up the main panel after the event of the electrical utility having gone off grid, {and thus de-energizing the inverter as required by design}; therefore the installed grid tied solar PV system may be utilized to produce power and re-feed the main panel whilst the transfer switch has disconnected from the grid.

The method by which this process is achieved is via an auxiliary “normally open” contact that closes when the automatic or manual transfer switch changes state due to the loss of utility power. This auxiliary contact will then close and allow dc power from a storage battery to power up an “off grid” inverter circuit that produces a 240 vac/60 hz supply that enables the primary string inverter or micro-inverters to re-power because the normally grid tied inverters must see a load side voltage in order to come online. Therefore the existing solar PV system is re-energized and thus powers up the main electrical panel. The transfer switch will remain in this state until the electrical utility has returned at a steady state for a period of 15 minutes which is controlled by a standard timer built into the transfer switch or manually transferred; at which this point the transfer switch will reverse state back to utility tied and the system will remain in this state until called upon as described.

The off grid battery is continually charged by a battery charger that is either powered from the grid or by the solar PV system.

This device by design of a parallel AC capacitor bank and DC battery bank (“if required by sizing demands”) can off-set the inductive load in-rush current and allow for the start-up of a motor load such as an air conditioner compressor and fan motor with the solar.

This device by design may also be used in conjunction with any other source of power such as a back-up generator thru the transfer switch, but does not require a generator to function as designed. In fact an alternate power source would open a set of “normally closed relays “R1” feed source to the “off grid” inverter and “R2” “off grid” inverter output; thus eliminating any dual feed to load side of primary string inverter.

This system may be utilized with PV panel micro inverters the same way it is utilized with a string inverter or multiple string inverters.

The drawing is a one line electrical schematic because this system may be utilized by either “single phase” or “three phase” systems of any size. The schematic included is typical of a standard 200 amp household service and may be sized to accommodate any size load.

All of the components utilized to build this device are UL listed electrical components and wire and installed in one 24″×24″ junction box. The system functions in parallel with a transfer switch in the same manner a generator would utilize a transfer switch (also known as a “Safety Switch”).

1. A device consisting of several components that acts electrically in a way when turned on to introduce a signal that tricks a grid tied solar PV system inverter into turning back on after having been disconnected from the grid, therefore allowing the Solar PV grid tied system to be utilized in an off-grid mode for as long as the utility grid is down.

2. A device according to claim 1, that can be utilized with virtually any grid tied solar PV inverter system that is dependent on the grid voltage and frequency to turn itself on.

3. A device according to claim 2, that can be adjusted to match any voltage and frequency generated by the utility grid to function anywhere that a utility grid is present.

4. A device according to claim 3, that can be safely integrated with any grid tied solar PV system due to being paired with a transfer switch which isolates the utility grid from the solar PV system.

5. A device according to claim 4, which meets the standards of the National Electric Code and retains the ISO 9001 standards implemented on a grid tied inverter system, in a way that accommodates the customer needs in a safe and user friendly manner.
